(19) United States
(12) Patent Application Publication
(10) Pub. No.: US 2010/0220882 A1
(43) Pub. Date: Sep. 2, 2010

(54) HEARING DEVICE WITH AN ACOUSTICS UNIT AND A SHELL PART

(75) Inventors: Stefanie Beyfuss, Erlangen (DE); Uwe Flaig, Feucht (DE); Holger Kral, Furth (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/715,787

(22) Filed: Mar. 2, 2010

(30) Foreign Application Priority Data
Mar. 2, 2009 (DE) 10 2009 011 292.8

(51) Int. Cl. H04R 25/00

(52) U.S. Cl. 381/322

(57) ABSTRACT

A hearing device with a replaceable shell concept is configured such that the visible parts of a housing can be replaced quickly and easily. Therefore, it should be possible to replace a shell using few manual operations. The novel hearing aid has an acoustics unit that can be inserted into a shell part, wherein the acoustics unit has a projection engaging into a correspondingly shaped region of the shell part when the acoustics unit is in the inserted state. As a result of the engagement of the projection into the region, a movement of the acoustics unit in a direction out of the shell part is automatically blocked. Additionally, the acoustics unit can be fixed in the shell part by a pin.

### CROSS-REFERENCE TO RELATED APPLICATION

This application claims the priority, under 35 U.S.C. §119, of German patent application DE 10 2009 011 292.8, filed Mar. 2, 2009; the prior application is herewith incorporated by reference in its entirety.

### BACKGROUND OF THE INVENTION

### Field of the Invention

The invention relates to a hearing device with an acoustics unit and a shell part into which the acoustics unit can be inserted. The term “hearing device” in this case is understood to mean a hearing aid in particular. Moreover, the term also includes other portable acoustic equipment, however, such as headsets, earphones, and the like.

Hearing aids are portable hearing devices used to support the hard-of-hearing. In order to make concessions for the numerous individual requirements, different types of hearing aids are provided, e.g. behind-the-ear (BTE) hearing aids, hearing aids with an external earpiece (receiver in the canal—RIC) and in-the-ear (ITE) hearing aids, for example concha hearing aids or canal hearing aids (ITE, CIC) as well. The hearing aids listed in an exemplary fashion are worn on the concha or in the auditory canal. Furthermore, bone conduction hearing aids, implantable or vibrotactile hearing aids are also commercially available. In this case, the damaged sense of hearing is stimulated either mechanically or electrically.

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually designed as an electroacoustic transducer, e.g. a miniaturized loudspeaker, or as an electromechanical transducer, e.g. a bone conduction earpiece. The amplifier is usually integrated into a signal-processing unit. This basic design is illustrated in FIG. 1 using the example of a behind-the-ear hearing aid. One or more microphones 2 for recording the sound from the surroundings are installed in a hearing-aid housing 1 to be worn behind the ear. A signal-processing unit 3, likewise integrated into the hearing-aid housing 1, processes the microphone signals and amplifies them. The output signal of the signal-processing unit 3 is transferred to a loudspeaker or earpiece 4, which emits an acoustic signal. If necessary, the sound is transferred to the eardrum of the equipment wearer using a sound tube that is fixed in the auditory canal with an ear mold. A battery 5 likewise integrated into the hearing-aid housing 1 supplies the hearing aid and in particular the signal-processing unit 3 with energy.

The electronic components of a hearing aid are often installed in a frame, which fixes the position of the former. A frame equipped with electronic components forms the acoustics unit of a hearing aid. The unit is installed in a housing, which is usually of a two-shell design. It is expedient to be able to assemble and disassemble the corresponding parts easily and quickly for servicing purposes or for being able to combine the color and/or shape of various housing parts.

The parts of a hearing aid are usually screwed together or fixed to one another using at least two pins. Screws or pins are disadvantageous in terms of the optical appearance of a hearing aid because they interrupt the closed nature of the outer surface and are usually very distinct therefrom in terms of color. Moreover, pins with slightly different lengths for design reasons can be interchanged and this likewise negatively influences the external appearance and the comfort of wear.

### SUMMARY OF THE INVENTION

It is accordingly an object of the invention to provide a hearing aid with an acoustics unit a a shell part which overcome the above-mentioned disadvantages of the heretofore-known devices and methods of this general type and which provides for a hearing device in which a shell can be interchanged easily, quickly and with as few additional parts as possible.

With the foregoing and other objects in view there is provided, in accordance with the invention, a hearing device, comprising:

an acoustics unit formed with a projection;

a shell part formed for insertion thereinto of said acoustics unit;

wherein said projection of said acoustics unit forms an engagement with a correspondingly shaped region of said shell part when said acoustics unit is inserted in said shell part, said engagement blocking a movement of said acoustics unit in a direction out of said shell part.

In other words, the hearing device according to the invention has an acoustics unit and a shell part into which the acoustics unit is inserted, wherein the acoustics unit has a projection engaging into a correspondingly shaped region of the shell part when the acoustics unit is in the inserted state, and wherein the engagement blocks a movement of the acoustics unit in a direction out of the shell part.

The hearing device according to the invention is advantageous in that the projection on the acoustics unit already prevents the acoustics unit from, in the inserted state, moving in the shell part in the specified direction. The acoustics unit is automatically fixed in respect of the movement direction out of the shell during the insertion. Thus, there is no need to insert a pin into an opening of the shell part in a time-consuming fashion.

The shell part need not form a complete shell of the hearing device. The complete shell can also comprise a plurality of parts. However, the shell part in this case preferably forms the predominant part of the complete shell and so, correspondingly, a predominant part of the acoustics unit is also surrounded by the shell part when the acoustics unit is inserted into the latter. For insertion, the acoustics unit is introduced into the shell part through an opening in the latter. In the process, the projection of the acoustics unit engages with the correspondingly shaped region of the shell part by means of a combined pivot/slide movement such that the acoustics unit can then no longer be directly lifted out of the shell part. The correspondingly shaped region thus forms an undercut as seen from the opening of the shell part, the shape of which undercut preferably corresponds to the shape of the projection. The projection engages in this undercut. In other words, the acoustics unit is hooked into this region by means of the projection.

The hearing device is advantageous if the acoustics unit in the inserted state has precisely one degree of freedom of movement in respect of the shell part. An acoustics unit inserted into a shell part has a total of six possible degrees of freedom of movement. It could translate in three different spatial directions and could additionally rotate about three orthogonal axes. A rotary movement also comprises tilting the acoustics unit if the acoustics unit is, for example, first of all picked up at one end and lifted for the purpose of removing it from the shell part in order subsequently to pull the other end out of the shell part.

By limiting the movement options of the acoustics unit in the shell part to one degree of freedom of movement, this advantageously results in the acoustics unit then being able to be fastened in the shell part by very simple means such that the acoustics unit and the shell part ultimately cannot move in relation to one another.

Advantageously, the movement allowed by the remaining degree of freedom is a rotation about an axis of rotation determined by the projection. Such a pivot or tilt movement allows the insertion of the acoustics unit into the shell part or the removal therefrom again, without the acoustics unit in the process jamming in the shell part.

In accordance with an additional feature of the invention, the acoustics unit is latched into the shell part in the inserted state. When assembling the hearing device, this affords easier handling of the shell part with an acoustics unit inserted therein.

In accordance with an added feature of the invention, the projection is advantageously formed by a step in an outer wall of the acoustics unit. A step can be formed, for example, on a frame of the acoustics unit with little effort.

A further advantage results from the projection being formed on a base of a connection piece for attaching a support hook. This region of an acoustics unit is usually produced from a relatively hard material. There is therefore little wear and tear on a projection in the case of frequent changing of the shell part if said projection is formed in this region of the acoustics unit. Moreover, this results in an expedient lever by means of which the projection keeps the acoustics unit in the shell part.

Moreover, it is advantageous in the process if the base has a further projection of the aforementioned type and the shell part correspondingly has a further region of the aforementioned type and the base is arranged between the two regions in the inserted state of the acoustics unit. By dividing the forces onto two projections, each individual projection is subjected to smaller loads. Accordingly, an undercut in a shell part, which usually comprises relatively soft plastics and corresponds to a projection, is also subjected to less load as a result thereof. This reduces the risk of damage to the projections or to a wall of the shell part in which a region corresponding to a projection is formed. The formation of symmetrical projections on both sides of the base again prevents a jamming of the acoustics unit in the shell part as well.

Furthermore, an advantageous development of the hearing device results from the acoustics unit in the inserted state being able to be fixed in the shell part by inserting a pin such that the acoustics unit and the shell part cannot move in relation to one another. In the process, the pin preferably passes through both the acoustics unit and at least one wall of the shell part as well. Inserting the pin also blocks those movements of the acoustics unit in the shell part that are still possible as a result of the remaining degrees of freedom of movement after an insertion.

This development advantageously allows the acoustics unit to be fixed in the shell part by means of a single pin.

In the process, it is also advantageous for the pin in the inserted state to form an axis of a hinge for a battery case of the hearing device. This allows the interconnection of three components of the hearing device by inserting a single pin, i.e. by a single manual operation.

Finally, an advantageous development of the hearing device according to the invention results from additional fixing of the position of the acoustics unit in the shell part by an interlocking connection. This additionally limits the freedom of movement of the acoustics unit before the pin is fitted, and thus makes work easier. Ribs and grooves, which can also be made without additional costs during the production of the parts, in the shell part and the acoustics unit preferably form the interlocking connection.

Other features which are considered as characteristic for the invention are set forth in the appended claims.

Although the invention is illustrated and described herein as embodied in a hearing device with an acoustics unit and a shell part, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an illustration of schematic design of a behind-the-ear hearing aid according to the prior art;

FIG. 2 is a perspective illustration of an acoustics unit and a shell part, which belong to a hearing aid according to one embodiment of the hearing device according to the invention; and

FIG. 3 is a perspective illustration of the shell part and the acoustics unit from FIG. 2, wherein both parts are only illustrated in part and from a different perspective and slightly enlarged in comparison with FIG. 2.

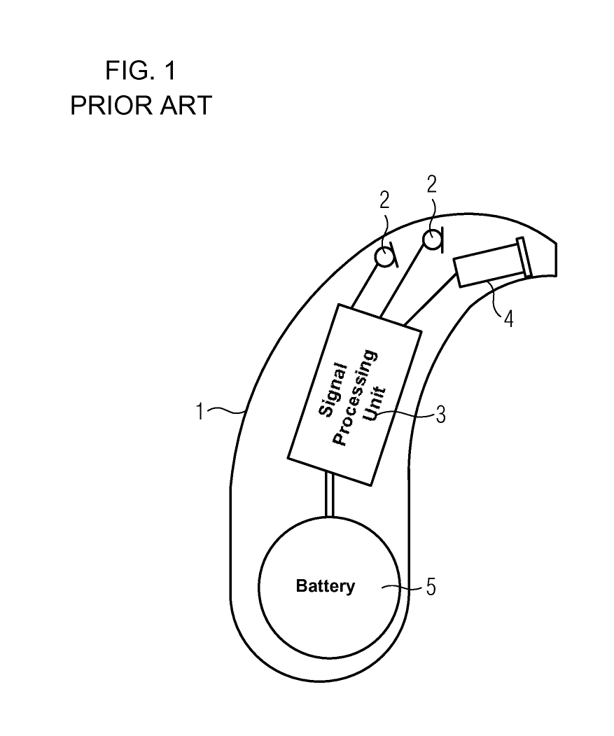

### DETAILED DESCRIPTION OF THE INVENTION

Referring now to the figures of the drawing in detail it should be understood, first, that the illustrated example constitutes a preferred embodiment of the invention.

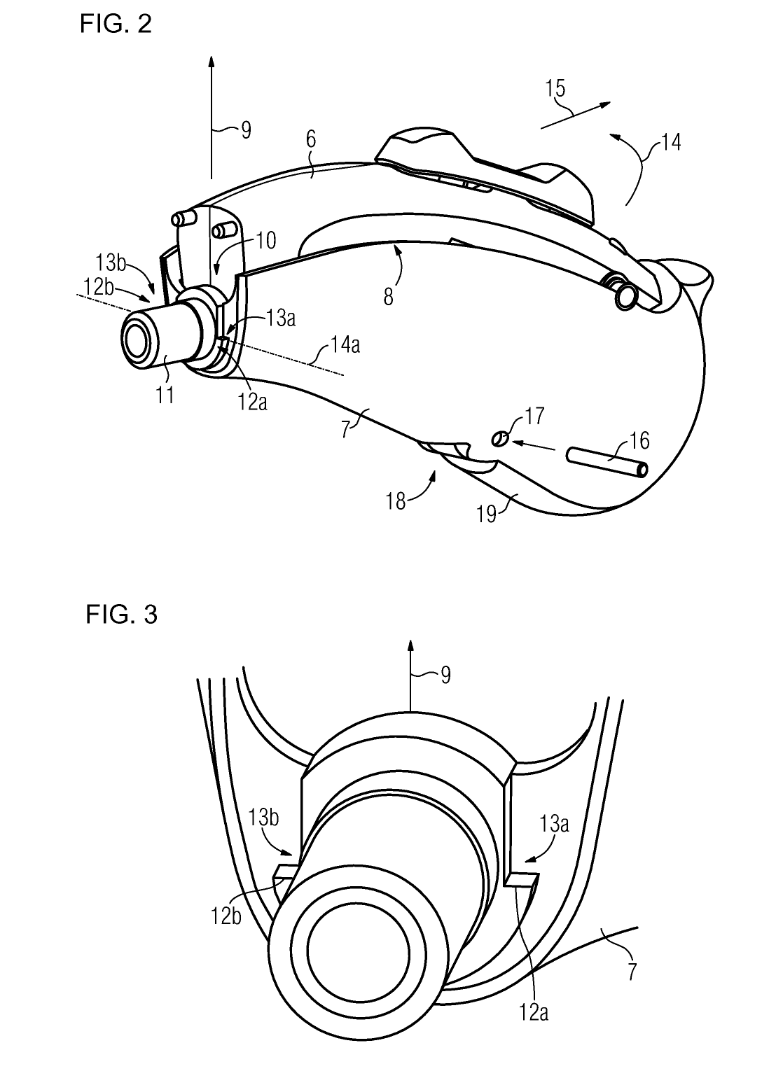

FIG. 2 illustrates an acoustics unit 6 and a shell part 7, which are components of a hearing aid that is not illustrated in any more detail in the figure. The hearing aid is built according to a replaceable shell concept, i.e. visible parts—this also includes the housing—can be replaced easily and quickly.

The acoustics unit 6 has been inserted into the shell part 7. Here, an upper part (in FIG. 2) of the acoustics unit 6 protrudes out of an opening 8 of the shell part 7. In FIG. 2, the arrow of the reference sign for the opening 8 points at an edge region of the opening 8 delimiting the opening 8. The upper part of the acoustics unit 6 can likewise be enclosed by a part not illustrated in FIG. 2.

The acoustics unit 6 cannot be lifted directly out of the shell part 7 along a direction indicated by a directional arrow 9 in FIG. 2. At a base 10 of a connection piece 11 for a support hook of the hearing aid not illustrated in FIG. 2, two steps 12a, 12b situated on two opposite sides of the connection piece 11 are formed. However, one of the two steps, step 12b, is covered by the connection piece 11 in the illustration of FIG. 2 and cannot be seen for this reason.

The two steps 12a, 12b block a movement of the acoustics unit 6 in the direction 9 because they respectively undercut a wall of the shell part 7 in a region 13a, 13b in respect of the direction 9. In FIG. 2, the region 13b, like the step 12b, is situated behind the connection piece 11 and cannot be seen for this reason.

The steps 12a and 12b engage in an undercut, formed in the respective region 13a, 13b in the wall of the shell part 7, in the regions 13a and 13b respectively, when the acoustics unit 6 is in the inserted state.

The base 10 is usually made of steel or ceramics; by contrast, the shell part 7 is made of plastics. Thus, the steps 12a, 12b do not suffer from wear and tear, even if the shell part 7 is often replaced by other shell parts.

In order to lift the acoustics unit 6 out of the shell part 7, the acoustics unit 6 must first of all be lifted out of the shell part in a pivoting movement, the course of which is clarified by a directional arrow 14. According to the invention, the acoustics unit 6 rotates about a rotational axis 14a. After pivoting the acoustics unit 6, the base 10 and the connection piece 11 can be pulled away from the regions 13a, 13b of the wall of the shell part 7 by a movement of the acoustics unit 6 in a direction indicated by a directional arrow 15.

In the inserted state shown in FIG. 2, the acoustics unit 6 can be securely fastened in the shell part 7 by sticking a pin 16 into an opening 17 in the shell part 7. When the pin 16 is inserted, it also partly sticks in the acoustics unit 6. At the same time, it also forms an axis of a hinge 18 for a battery compartment 19 of the hearing aid.

Even without the pin 16 being inserted, the acoustics unit 6 does not lie in the shell part 7 in a loose fashion. A latching mechanism not illustrated in FIG. 2 secures the acoustics unit 6 against falling out. However, the acoustics unit 6 can be detached from a hold of the latching mechanism by means of relatively low forces.

FIG. 3 again illustrates, from a different perspective, a region of the acoustics unit 6 and a region of the shell part 7 that were already described in conjunction with FIG. 2. Thus, reference signs are provided in FIG. 3 that correspond to those of FIG. 2.

The slightly enlarged illustration shows how the steps 12a and 12b respectively engage in an undercut in the region 13a and 13b respectively. In respect of the direction of the directional arrow 9, this engagement constitutes an undercut of part of the wall of the shell part 7 by the steps 12a, 12b. This undercut, in terms of the invention, blocks a movement of the acoustics unit 6 out of the shell part 7, namely in the direction of the directional arrow 9.

The functional principle of the elements shown in FIG. 2 and FIG. 3 is briefly illustrated once again in the following text.

The shell part 7 forms part of a housing of the hearing aid. At the position of the connection piece for the support hook, said shell part is shaped such that the acoustics unit 6 is inserted into the shell part 7 with only one degree of freedom remaining available. This degree of freedom is locked by a latching mechanism in the acoustics unit and in the shell part. The latching mechanism is designed such that the acoustics unit can also be disassembled again. Then, the acoustics unit 6 is ultimately secured in the shell part 7 by a single pin 16, which is used simultaneously for fixing the position of the acoustics unit 6 and as a rotational axis for the battery case 19.

This solution requires one fewer pin for the assembly as compared with the prior art. This results in costs being saved during the assembly. Moreover, fewer parts are required. Mistaking pins of various lengths is eliminated. The replaceable shell, that is to say the shell part 7, can be replaced quickly and easily.

1. A hearing device, comprising:
an acoustics unit formed with a projection;
a shell part formed for insertion thereinto of said acoustics unit;
wherein said projection of said acoustics unit forms an engagement with a correspondingly shaped region of said shell part when said acoustics unit is inserted in said shell part, said engagement blocking a movement of said acoustics unit in a direction out of said shell part.

2. The hearing device according to claim 1, wherein, when said acoustics unit is inserted, said acoustics unit has precisely one degree of freedom of movement with respect to said shell part.

3. The hearing device according to claim 2, wherein said one degree of freedom of movement is a rotation about an axis of rotation, as determined by said projection.

4. The hearing device according to claim 1, wherein said acoustics unit is latched into said shell part in an inserted state thereof.

5. The hearing device according to claim 1, wherein said projection is a step formed in an outer wall of said acoustics unit.

6. The hearing device according to claim 1, wherein said projection is formed on a base of a connection piece for attaching a support hook.

7. The hearing device according to claim 6, wherein:
said projection is one of two projections formed on said base and said shaped region of said shell part is one of two shaped regions for engagement with said projections; and
said base is disposed between said two regions in the inserted state of said acoustics unit.

8. The hearing device according to claim 1, wherein said acoustics unit, in an inserted state thereof, is fixed in said shell part by a pin inserted therein, such that said acoustics unit and said shell part cannot move relative to one another.

9. The hearing device according to claim 8, which further comprises a battery case pivotally mounted to said shell part, and wherein said pin, in the inserted state thereof, forms an axis of a hinge for said battery case of the hearing device.
